(19) United States
(12) Patent Application Publication
(10) Pub. No.: US 2009/0044580 A1
(43) Pub. Date: Feb. 19, 2009

(54) Corpse Treatment Method

(75) Inventor: Evert Dirk Van Ramshorst, Amstelveen (NL)

Correspondence Address: THE WEBB LAW FIRM, P.C., 700 KOPPERS BUILDING, 436 SEVENTH AVENUE, PITTSBURGH, PA, 15219, US

(73) Assignee: E.D. VAN RAMSHORST BEHEER B.V., Amstelveen (NL)

(21) Appl. No.: 12/160,699

(22) PCT Filed: Jan. 15, 2007
(86) PCT No.: PCT/NL07/50016

§ 371 Date: Oct. 1, 2008

(30) Foreign Application Priority Data
Jan. 13, 2006 (NL) 1030919
Feb. 16, 2006 (NL) 1031166

(51) Int. Cl. C05F 1/00; A61G 17/08; A01G 9/02

(52) U.S. Cl. 71/15; 27/1; 47/65.5

(57) ABSTRACT

A method for handling the bodily remains of a human or animal comprises the following steps, to be performed in suitable sequence, of: (a) providing a receptacle at least partly filled with soil material, for instance potting compost or hydroculture granules; (b) allowing a plant, such as a tree, a shrub, a bonsai tree or a house-plant, to grow in this soil material; and (c) adding at least components of the bodily remains to this plant.

The invention relates to a method for handling the bodily remains of a human or animal.

In addition to being buried, the deceased are often cremated. Following cremation, the ashes are kept in an urn by the crematorium and released after a determined period of time. The ashes can then be scattered or placed in a niche. Scattering is for instance possible at sea or at a scattering site. Placing is possible at the crematorium in an urn wall or columbarium, in an urn garden, urn crypt or in a special object. The ashes can also be placed at a cemetery or taken home. Scattering at another, personally selected scattering site is also possible. In addition, there are commemorative objects with the ashes of the deceased incorporated therein, such as a glass sculpture or a medallion. An artificial diamond can also be manufactured from the cremation ashes of the deceased.

A new form of corpse treatment has also been developed: freeze-drying or lyophilization. In freeze-drying the body of the deceased is cooled to −18° C. The frozen body is then immersed in a bath of liquid nitrogen. The frozen body then becomes very fragile. By then subjecting it to vibrations, the body falls apart into a kind of powder from which the moisture is then extracted by means of vacuum. A dry, odourless powder with a weight in the order of 25 to 30 kg eventually remains.

EP-A-0 623 717 proposes to have the ashes of the deceased taken up in a plant, usually a tree, so that a living monument is obtained as a memory of the deceased. The ash is here placed in the vicinity of roots of the plant. Washing of the ash out of the ground will however generally take place much more quickly than the absorption of the ashes by the plant, so that only a small part of the ash will actually be taken up into the living plant.

It is an object of the invention to provide a method for corpse treatment wherein the greatest possible part of the bodily remains is absorbed into the plant.

In this respect the invention provides a method of the stated type, which is characterized by the following steps, to be performed in suitable sequence, of:

(a) providing a receptacle at least partly filled with soil material, for instance potting compost or hydroculture granules;

(b) allowing a plant, such as a tree, a shrub, a bonsai tree or a house-plant, to grow in this soil material; and

(c) adding at least components of the bodily remains to this plant.

In the context of the present invention a “receptacle” must also be understood to mean a tub, crate, container, bag and so on in which the plant can grow. What is important is that the container confines the remains such that there is no dissemination into the environment, or at least the dissemination takes place much more slowly than the absorption by the plant, so that as many components as possible are taken up by the plant.

A tree is preferably selected as the plant. A tree generally has a relatively long lifespan, whereby the living monument is available to relatives for a relatively long time. Shrubs are for instance also well suited for this purpose.

A house-plant can also be selected as the plant. The container with house-plant can then for instance be placed indoors, in the living room, so that relatives will always have the living monument in very close proximity.

In a preferred embodiment the method step (d) comprises of reducing at least part of the bodily remains to an amorphous mass, for instance granules or a powder, prior to step (c).

This step can be carried out by for instance cremation, freeze-drying or any other suitable method.

A specific method according to the invention comprises step (g) of adding the mass obtained with step (d) directly to the soil material.

In an alternative embodiment the method comprises the steps of

(h) dissolving in water water-soluble components of the mass obtained with step (d); and

(i) performing step (c) by adding the thus obtained solution to the plant.

A specific embodiment hereof comprises step (j) of performing step (h) by filtration, for instance with unheated water, or step (k) of performing step (h) by extraction or infusion, for instance with hot water.

According to another aspect of the invention, the method step (l) comprises of performing step (i) by adding the solution, optionally in portions, to the soil material.

In another embodiment the method step (m) comprises of performing step (i) by applying the solution to the leaves, needles, flowers, stems, trunk and/or branches of the plant, for instance by spraying.

In yet another method the method step (n) comprises of performing step (i) by injecting the solution, optionally in portions, into the trunk, the stem and/or the branches of the plant such that it is taken up into the sap flow.

According to yet another aspect of the invention, the method step (o) comprises of performing step (a) by using a receptacle of biodegradable material.

The receptacle with the bodily remains and the plant can thus be planted directly in the ground at a desired location. After a time, once at least a greater part of the bodily remains have been absorbed by the plant, the receptacle will have decomposed so that the plant then stands freely in the open ground and can continue to grow unhindered.

The method step (p) preferably comprises of replanting the plant in the open ground after a certain time after performing step (c). This time can be chosen such that the bodily remains are at least for the greater part absorbed by the plant. The plant can thus first grow to a determined size, for instance carefully tended by a gardener, and then be planted at a more definitive, selected location.

In a final variant the method step (q) comprises of performing step (p) for a number of plants, such that a group of plants with components of bodily remains is obtained. The plant can thus be planted in a remembrance garden together with other plants which have been grown in similar manner. It is thus possible to lay out a peaceful, attractive and natural garden or park which people can visit in the knowledge that the plants, shrubs or trees have grown with components of the deceased.

The invention further relates to a device for performing a method of the above described type. Such a device comprises: a receptacle intended and adapted to be at least partly filled with soil material, for instance potting compost, in which a plant such as a tree, a shrub, a bonsai tree or a house-plant can be grown;

a container for storing at least components of the bodily remains.

In a specific embodiment the device has the special feature that the receptacle and the container are connected non-releasably to each other.

According to another aspect of the invention, the device has the special feature that the receptacle and the container can be releasably connected to each other.

The invention will be elucidated hereinbelow on the basis of a number of non-limitative exemplary embodiments of a method according to the invention.

In a preferred embodiment of a method according to the invention a receptacle is filled with a mixture of potting compost and the remains of the deceased. A young tree is planted therein. The care, fertilizing and watering can then be optimal and can for instance be carried out by a specialized company. The tree remains in the receptacle or tub until it is properly rooted and the remains, or at least components, have been taken up via the roots. The tree with root ball can then be removed from the receptacle or tub and planted at a selected location, for instance a private garden or a park laid out for this purpose, and thus form a living monument of the deceased for relatives.

In a second exemplary embodiment of a method according to the invention a receptacle of biodegradable material is used. The receptacle with the bodily remains and the plant can now be placed directly in the ground at a desired location. Later replanting is then not necessary. In the course of time the receptacle or tub will decompose and the plant can continue to grow unhindered.

In a third exemplary embodiment of a method according to the invention a decorative pot is filled with a mixture of potting compost and the remains of the deceased. A house-plant is planted therein. The decorative pot with the bodily remains and the plant can now be placed directly indoors, for instance in the living room.

A device for performing a method according to the invention can for instance comprise a shallow dish which is partially filled with soil material and in which a bonsai tree grows. At least one thin water drainage pipe for instance connects to the dish, and debouches on the underside of the support elements for the dish. Under the bonsai dish and between the water drainage pipe or pipes and possible further support legs there fits a container for at least components of bodily remains, for instance an urn. This is carried by a second dish which serves to collect possible excess water from the soil material of the bonsai dish. The container is carried by support elements such that the urn is always some distance above the water level in the water dish.

The container can also be an indoor or outdoor plant box, wherein the container, for instance hidden from view, is in this case also incorporated in the overall construction. When a relative wishes to add components of the bodily remains to the soil material or in other manner to the plant, he/she effects access to the container.

The receptacle can also be a vase which is optionally coupled releasably to the container, for instance an urn.

1-17. (canceled)

18. A method for handling the bodily remains of a human or animal, comprising the following steps, to be performed in suitable sequence, of:
(a) providing a receptacle at least partly filled with soil material, for instance potting compost or hydroculture granules;
(b) allowing a plant, such as a tree, a shrub, a bonsai tree or a house-plant, to grow in this soil material; and
(c) adding at least components of the bodily remains to this plant.

19. The method as claimed in claim 18, comprising the step of:
(d) reducing at least part of the bodily remains to an amorphous mass, for instance granules or a powder, prior to step (c).

20. The method as claimed in claim 19, comprising the step of:
(e) performing step (d) by cremation.

21. The method as claimed in claim 19, comprising the step of:
(f) performing step (d) by freeze-drying.

22. The method as claimed in claim 19, comprising the step of:
(g) adding the mass obtained with step (d) directly to the soil material.

23. The method as claimed in claim 19, comprising the steps of:
(h) dissolving in water water-soluble components of the mass obtained with step (d); and
(i) performing step (c) by adding the thus obtained solution to the plant.

24. The method as claimed in claim 23, comprising the step of:
(j) performing step (h) by filtration, for instance with unheated water.

25. The method as claimed in claim 23, comprising the step of:
(k) performing step (h) by extraction or infusion, for instance with hot water.

26. The method as claimed in claim 23, comprising the step of:
(l) performing step (i) by adding the solution, optionally in portions, to the soil material.

27. The method as claimed in claim 23, comprising the step of:
(m) performing step (i) by applying the solution to the leaves, needles, flowers, stems, trunk and/or branches of the plant, for instance by spraying.

28. The method as claimed in claim 23, comprising the step of:
(n) performing step (i) by injecting the solution, optionally in portions, into the trunk, the stem and/or the branches of the plant such that it is taken up into the sap flow.

29. The method as claimed in claim 18, comprising the step of:
(o) performing step (a) by using a receptacle of biodegradable material.

30. The method as claimed in claim 18, comprising the step of:
(p) replanting the plant in the open ground after performing step (c).

31. The method as claimed in claim 18, comprising the step of:
(q) performing step (p) for a number of plants, such that a group of plants with components of bodily remains is obtained.

32. A device for handling the bodily remains of a human or animal, comprising:
a receptacle intended and adapted to be at least partly filled with soil material, for instance potting compost, in which a plant such as a tree, a shrub, a bonsai tree or a house-plant can be grown; and
a container for storing at least components of the bodily remains.

33. The device as claimed in claim 32, wherein the receptacle and the container are connected non-releasably to each other.

34. The device as claimed in claim 32, wherein the receptacle and the container can be releasably connected to each other.
